(19) United States
(12) Patent Application Publication
(10) Pub. No.: US 2018/0147830 A1
(43) Pub. Date: May 31, 2018

(54) INKJET PRINTING ASSEMBLY AND INKJET PRINTING METHOD

(71) Applicant: Océ Holding B.V., Venlo (NL)

(72) Inventors: Daniël H.A. DRIESSEN, Venlo (NL); Pim DU BUF, Venlo (NL)

(73) Assignee: Océ Holding B.V., Venlo (NL)

(21) Appl. No.: 15/817,528

(22) Filed: Nov. 20, 2017

(30) Foreign Application Priority Data
Nov. 28, 2016 (EP) 16200997.1

(51) Int. Cl. B41J 2/005

(52) U.S. Cl. CPC B41J 2/0057

(57) ABSTRACT

An inkjet printing assembly is configured for providing an imaging liquid on a recording medium. The inkjet printing assembly comprises a transport path for transporting an intermediate medium and the inkjet printing assembly has arranged along said transport path a first inkjet print station for ejecting a process liquid on an intermediate medium prior to ejecting the imaging liquid on the intermediate medium; a second inkjet print station for ejecting the imaging liquid on the intermediate medium; a spreading treatment station arranged between the first print station and the second print station for treating the process liquid on the intermediate medium before receiving the imaging liquid on the intermediate medium; and a transfer station for transferring at least the imaging liquid from the intermediate medium to the recording medium.

### FIELD OF THE INVENTION

The present invention generally pertains to an inkjet printing assembly and method, wherein a process liquid is applied on an intermediate medium, an imaging liquid is applied on the intermediate medium and at least the imaging liquid is transferred to a recording medium.

### BACKGROUND ART

In inkjet printing, droplets of liquid are ejected from an inkjet print head. In commonly known drop-on-demand (DOD) inkjet, a droplet is only generated when needed, but other kinds of inkjet printing are also known in the art.

An imaging liquid, such as an ink, may be applied directly on a recording medium. The imaging liquid then needs to solidify. Solidification is inter alia known to be performed by cooling, curing and/or drying. During solidification, the recording medium may become distorted due to tension generated by the solidification of the droplets and/or by moist entering the recording medium. For example, an aqueous imaging liquid may dry, while water may be absorbed in a paper sheet. High moisture content in the paper sheet may deform the sheet and after drying the paper sheet may be wrinkled or curled due to this process.

It is known that the above problems of direct inkjet printing may be diminished by indirect inkjet printing. In indirect inkjet printing, the imaging liquid is first applied on an intermediate medium. The intermediate medium may be selected to have properties such that the problems occurring in direct inkjet printing do not occur. For example, the intermediate medium may be selected such that the intermediate medium does not absorb any compounds from the imaging liquid. The imaging liquid applied on the intermediate medium may then solidify to a predetermined extent and is then transferred from the intermediate medium to a recording medium. Since the imaging liquid has already solidified to a certain predetermined extent, the impact on the recording medium is reduced, preferably to such extent that the recording medium does not deform or distort.

On the other hand, the transfer of the imaging liquid from the intermediate medium to the recording medium needs to be very good. If imaging liquid remains on the intermediate medium, an image quality of an image formed by the imaging liquid on the recording medium is deteriorated. Further, the intermediate medium becomes polluted and re-use of the intermediate medium may become a challenge.

Further, properties of the intermediate medium, in particular in respect of the interaction with the imaging liquid, are important for obtaining a sufficient image quality. The droplets applied on the intermediate medium need to flow to a predetermined extent, while not fully coalescing with neighboring droplets. The droplets need to solidify to a predetermined extent without adhering to the intermediate medium, while still being able to adhere to the recording medium.

In view of the above requirements on the intermediate medium, in particular for a good transfer yield, it is known to apply an intermediate medium having a low surface energy, such as silicone rubbers, for example. The low surface energy however reduces the spreading of the imaging liquid on such surfaces. US 2006/152566 A1 discloses to use a treatment of the surface of the intermediate medium, for example treating with plasma, to make the surface more hydrophilic. Further, US 2006/152566 A1 discloses the use of a treatment liquid for thickening the imaging liquid in order to realize a good image quality. This kind of treatment liquid is commonly also referred to as a pinning liquid. US 2006/164488 A1 discloses a similar indirect inkjet printing process, wherein first a wetting liquid is applied on the intermediate medium and then a pinning liquid is applied on top of the wetting liquid. Hence, in general, it is apparent that obtaining an intermediate medium having the exactly optimal properties is not easy.

In both above-mentioned publications, the pinning liquid and the wetting liquid are applied by a roller providing a full layer of such liquids on the intermediate medium. As a consequence, such liquids are transferred to the recording medium with the imaging liquids at least in the regions where no imaging liquids are applied. In those regions, such liquids are brought into contact with the recording medium and it is virtually impossible to prevent a transfer from the intermediate medium to the recording medium, resulting in an always same appearance of the recording medium irrespective of the type of recording medium selected.

Further, the liquids coated on the intermediate medium remain on the intermediate medium at least in the regions where no contact with a recording medium is made: for example between recording medium sheets and beside the recording medium sheet edges.

Even further, considering that the pinning and wetting liquid is only needed for handling the imaging liquid, a relatively large amount of pinning and wetting liquid is just wasted, increasing costs not only for supplying sufficient liquid but also for cleaning the intermediate medium, for example.

The above-mentioned disadvantages of coated liquids, U.S. Pat. No. 9,138,985 discloses to apply a sacrificial coating liquid image-wise in droplets, e.g. by an inkjet printing method. Still, application by inkjet printing imposes again the same limitations as inkjet printing the imaging liquid, such as sufficient spreading, for example. Moreover, additional requirements are now imposed on the treatment liquid. The treatment liquid is required to have a sufficiently low viscosity such that it may be jetted through inkjet printing and is required to have a sufficiently high surface tension in order to prevent leaking from the inkjet print head.

It is an object of the present invention to provide for an inkjet printing assembly and method in which the above disadvantages are mitigated.

### SUMMARY OF THE INVENTION

In a first aspect of the present invention, an inkjet printing assembly according to claim 1 is provided. In particular, the inkjet printing assembly according to the present invention is configured for providing an imaging liquid on a recording medium. The inkjet printing assembly comprises a transport path for transporting an intermediate medium. The inkjet printing assembly has arranged along said transport path a first inkjet print station for ejecting a process liquid on an intermediate medium prior to ejecting the imaging liquid on the intermediate medium; a second inkjet print station for ejecting the imaging liquid on the intermediate medium; a spreading treatment station arranged between the first print station and the second print station configured to spread the process liquid on the intermediate medium before receiving the imaging liquid on the intermediate medium; and a transfer station for transferring at least the imaging liquid from the intermediate medium to the recording medium.

The inkjet printing assembly according to the present invention comprises a spreading treatment station for spreading the process liquid applied droplet-wise on the intermediate medium. The process liquid may be a pinning liquid, a wetting liquid, a release liquid, or any other sacrificial liquid. The process liquid may be intended to remain invisible on the recording medium, while the imaging liquid is intended to be visible and thus to form a visible image on the recording medium. As such, it is considered that the process liquid may be spreaded without significantly affecting an image quality which could occur if such spreading treatment was directly applied on the imaging liquid. By spreading the applied process liquid, dewetting or beading may be counteracted, for example, thereby enabling a suitable and jettable process liquid by lowering the requirements on such process liquid.

The spreading of the process liquid may be performed by any suitable kind of interaction with the liquid. A mechanical contact may be induced using a suitable spreading device. Examples of suitable spreading devices are described hereinbelow. Another exemplary spreading means may be, for example, an air blowing device, e.g. an air knife or the like, blowing air with sufficient pressure to deform and spread the process liquid. Such an air blowing device may, synergistically, improve drying of the process liquid.

In order to prevent any doubt, although invisible, the process liquid may affect the visual appearance of a printed image. For example, the process liquid may affect the glossiness of the printed image. Likewise, the presence of the process liquid may as well affect the visual appearance of the recording medium in areas where no imaging liquid is applied.

In an embodiment, the intermediate medium may be formed by an endless member being driven along said transport path, wherein such endless member may be an endless belt or a drum. In another embodiment, a transport medium may be configured for carrying the intermediate medium along the transport path. For example, an endless belt or drum may be configured to receive a sheet of the intermediate medium thereon and transport such sheet along the transport path. In such embodiment, it may be that the transport medium may as well be configured to transport a recording medium along the transport path, thereby enabling to perform direct inkjet printing on the recording medium as well. In particular, if a recording medium is transported along the transport path, the first print station and the spreading treatment station may remain inactive, since the treatment liquid may be configured to improve the process liquid and interaction between imaging liquid and intermediate medium, which process liquid and intermediate medium are both omitted during direct inkjet printing. In general, the present invention is not considered to be limited to any kind of form of the intermediate medium or to any kind of form or method for transporting the intermediate medium along the transport path.

In an embodiment, the spreading treatment station comprises a flattening device for flattening droplets of process liquid arranged on the intermediate medium. As mentioned above, the requirements on the intermediate medium and the process liquid are such that it is known that the process liquid may not be wetted on the intermediate medium. As a consequence, the process liquid may form beads on the intermediate medium. It may however be preferred that a local coating or uniform layer of process liquid is formed, for example for preventing that the imaging liquid coalesces with the process liquid instead of flowing over the intermediate medium to form a smooth layer of imaging liquid. A flattening device may therefore be provided to flatten the beads, thereby spreading the process liquid over the intermediate medium. Such a flattening device may be embodied as a roller arranged over the intermediate medium or as a wiper arranged over the intermediate medium.

In an embodiment, the spreading treatment station comprises a thickening device for increasing a viscosity of the process liquid arranged on the intermediate medium. In order to prevent uncontrolled flow, either uncontrolled spreading or uncontrolled beading, the viscosity may be increased. Such viscosity increase may be realized by evaporation of a carrier liquid, such as water, for example by application of heat, or may be realized by inducing a chemical reaction, e.g. polymerization and the like, for example by application of a curing radiation or application of heat. The person skilled in the art readily understands how a viscosity of a liquid may be increased and which means may be applied thereto.

In an embodiment, the spreading treatment station comprises a flattening device for flattening droplets of process liquid arranged on the intermediate medium as above mentioned and the thickening device is arranged upstream of the flattening device. So, in this embodiment, the viscosity of the applied process liquid is first increased to immobilize the process liquid and only thereafter the process liquid is flattened, effectively preventing uncontrolled coalescence or uncontrolled beading.

In another embodiment in which the spreading treatment station comprises a flattening device for flattening droplets of process liquid arranged on the intermediate medium, the flattening device and the thickening device are embodied in a single element. For example, the single element is a heated roller arranged over the transport path, the process liquid being flattened by pressure exerted by the roller and the process liquid being thickened by being at least partly dried by the heat applied by surface contact between the roller and the process liquid.

In a further embodiment, the inkjet printing assembly further comprises a cleaning station arranged downstream of the transfer station for cleaning the intermediate medium and a return transport path is provided for returning the intermediate medium to the first printing station. For example, the intermediate medium may be embodied as an endless belt, which inevitably includes such a return path. The cleaning station ensures that if a transfer of the imaging liquid and/or the process liquid is not complete and some of said liquids remains on the returning intermediate medium, such remaining liquids are removed before the next image is generated on the intermediate medium.

In a further aspect of the present invention, an inkjet printing method for providing an imaging liquid on a recording medium is provided. The inkjet printing method comprises transporting an intermediate medium along a transport path, ejecting a process liquid on the intermediate medium prior to ejecting the imaging liquid on the intermediate medium at a first inkjet print station; ejecting the imaging liquid on the intermediate medium at a second inkjet print station; treating the process liquid on the intermediate medium before receiving the imaging liquid on the intermediate medium at a spreading treatment station arranged between the first print station and the second print station; and transferring at least the imaging liquid from the intermediate medium to the recording medium at a transfer station.

In an embodiment, the process liquid is applied on the intermediate medium only at a position where the imaging liquid is to be applied. Thus, an unnecessarily excessive use of process liquid is prevented, which reduces costs and improves a perception of the printed result, since no process liquid needs to be transferred to the recording medium at the locations where no imaging liquid is present.

In an embodiment, the process liquid has a non-wetting property on the intermediate medium such that the process liquid may form beads on the intermediate medium and the step of treating the process liquid on the intermediate medium comprises flattening beads of process liquid.

In an embodiment, the step of treating the process liquid comprises increasing a viscosity of the process liquid, allowing better control over flow behavior of the process liquid on the intermediate medium.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying schematical drawings which are given by way of illustration only, and thus are not limitative of the present invention, and wherein:

FIG. 1 schematically illustrates a first embodiment of the present invention;

FIG. 2 schematically illustrates a second embodiment of the present invention;

FIG. 3 schematically illustrates a third embodiment of the present invention;

FIG. 4 schematically illustrates a fourth embodiment of the present invention; and

FIG. 5 schematically illustrates a fifth embodiment of the present invention.

### DETAILED DESCRIPTION OF THE DRAWINGS

The present invention will now be described with reference to the accompanying drawings, wherein the same reference numerals have been used to identify the same or similar elements throughout the several views.

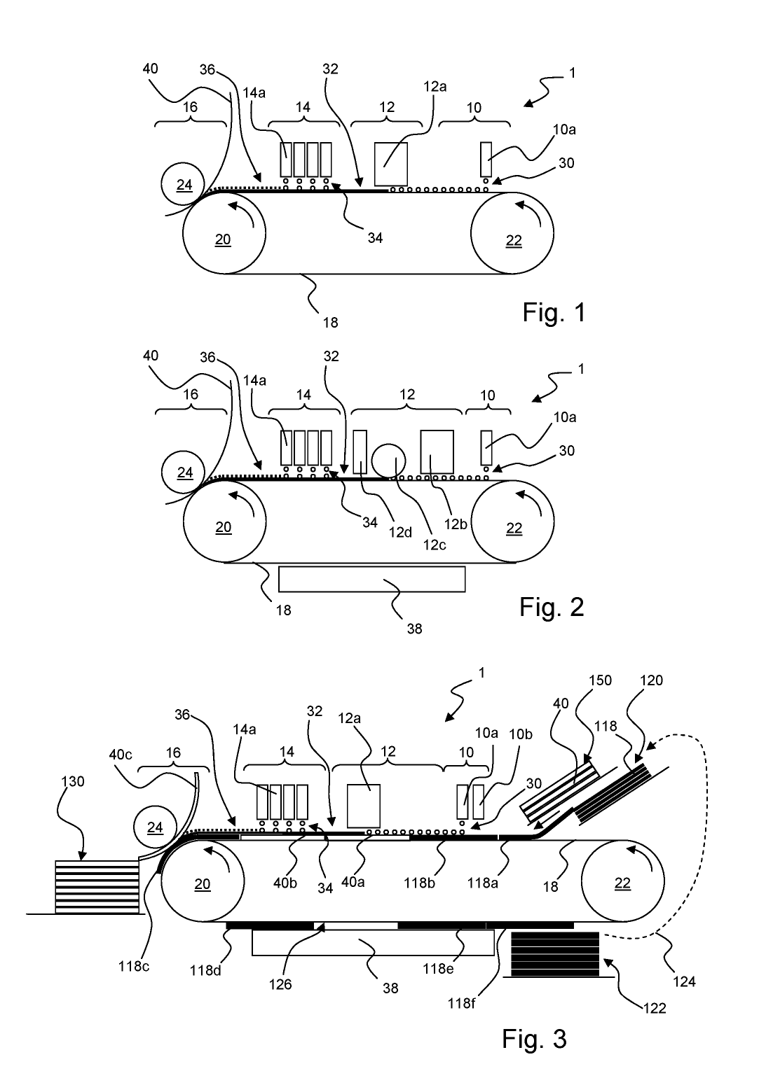

FIG. 1 illustrates an inkjet printing assembly 1 according to the present invention, wherein an endless belt 18 is arranged around a first roller 20 and a second roller 22. The endless belt 18 is moveable by turning of the first and second roller 20, 22, which is commonly achieved by driving only one of the two rollers 20, 22. In general, a person skilled in the art is enabled to select any suitable method and arrangement for driving such an endless belt 18. In any case, the endless belt 18 is driven such that a surface of the endless belt 18 is moved over a transport path in a direction in which the surface sequentially passes along a first inkjet print station 10, a spreading treatment station 12, a second inkjet print station 14 and a transfer station 16.

In the illustrated embodiment, the first print station 10 comprises an inkjet print head 10a for providing a process liquid 30 on the surface of the endless belt 18. The process liquid 30 may be any kind of liquid that has an effect on the print process performed by the inkjet printing assembly 1. For example, a pinning liquid may be applied for pinning any subsequently applied liquid such as an ink or a second process liquid. Similarly, a wetting agent or a release agent may be applied on the surface of the endless belt 18. At the spreading treatment station 12, a spreading treatment unit 12a performs a spreading treatment of the process liquid 30. Such spreading treatment may take any kind of suitable form. Specific embodiments are discussed hereinbelow in more detail.

As an example, as illustrated in FIG. 1, beaded droplets of process liquid 30 on the surface of the endless belt 18 are flattened by the spreading treatment unit 12a to form a process liquid film 32.

At the second print station 14, at least one print head 14a provides a second liquid such as an ink 34, or a similar image recording substance, forming a print image 36 on top of the process liquid film 32. The ink 34 may be affected by the process liquid 30, for example the ink 34 may be pinned or may spread and coalesce in a controlled way, but the ink 34 does not necessarily have to interact with the process liquid 30. For example, the process liquid 30 may be a release agent that only ensures that the ink 34 is released from the surface of the endless belt 18 at the transfer station 16.

At the transfer station 16, a counter roller 24 is provided forming a transfer nip. A recording medium 40 is transported through the transfer nip together with the endless belt 18. The print image 36 is transferred to the recording medium 40 in the transfer nip. The process liquid film 32 may be transferred as well or the process liquid film 32 may completely or in part remain on the surface of the endless belt 18.

The first print station 10 may apply as much process liquid 30 as desired depending on the print application. For example, the first print station 10 in combination with the spreading treatment station 12 may form a process liquid film 32 that completely covers the surface of the endless belt 18. In another example, the first print station 10 may apply the process liquid 30 in accordance with the image to be printed. In such embodiment, each location on the surface of the endless belt 18 where at least one droplet of ink 34 is to be applied at the second print station receives at least one droplet of process liquid 30 in the first print station 10, while the locations of the surface of the endless belt 18 where no ink 34 will be applied will receive no process liquid 30. In the latter embodiment, it is prevented that the process liquid 30 may be transferred to the recording medium 40, which would change the appearance of the recording medium 40 in areas where no ink 34 is applied. Further, such an image-wise application of the process liquid reduces the amount of process liquid needed, reducing costs and waste.

In view of removal of the process liquid 30 and the ink 34 from the surface of the endless belt 18, it may be preferred that both process liquid 30 and the ink 34 do not stick on the intermediate medium, i.e. the endless belt 18, and are thus easily removed from the endless belt 18. Thereto, the composition of the ink 34, the composition of the process liquid 30 and the physical properties of the surface of the endless belt 18 are preferably adapted to achieve an easy transfer of the ink 34 and the process liquid 30.

On the other hand, specific requirements on a print quality require specific properties of the ink 34, especially where the print quality is preferably independent from properties of a kind of the recording medium 40 used. In any case, in the present invention, the ink 34 is mostly provided on the process liquid 30. So, sticking of the process liquid 30 to the surface of the endless belt 18 is probably a more important aspect.

In general, a good transfer rate is in the prior art usually achieved by application of an endless belt 18 having a low surface energy, such as a belt having a top surface of silicone rubber materials. Spreading of a liquid, such as an ink or a process liquid, is usually limited and insufficient. For a good print quality, sufficient spreading is however needed. In view of the desired application by an inkjet print head 10a, the viscosity of the process liquid 30 needs to be sufficiently low, for example lower than 15 mPa·s, preferably lower than 10 mPa·s and even more preferably the viscosity is about 5 mPa·s and further the process liquid 30 has to have a sufficiently high surface tension to prevent the process liquid 30 leaking out of the print head 10a.

Considering the high number or requirements on both the process liquid 30 and the ink 34, the present invention has considered relieving the requirements by enabling the process liquid 30 not to have certain features, but to compensate such lack of features by a spreading treatment station 12. The process liquid 30 may thus be easily adapted to be jetted by an inkjet print head 10a and be image-wise applied on the intermediate medium. On the intermediate medium, the process liquid 30 may bead, for example, which may be compensated at the spreading treatment station 12 by flattening of the beads of process liquid 30, effectively achieving sufficient spreading of the process liquid 30. If desired or needed, the spreading treatment station 12 may further provide for stimulation of drying or (pre-)curing of the process liquid 30 to prevent that the process liquid 30 starts to bead again. Further, the surface of the intermediate medium may be adapted to the process liquid 30 and the spreading treatment thereof at the spreading treatment station 12. For example, a surface structure may be applied to obtain a relatively high surface roughness, e.g. a surface roughness Ra of about 1 micron. Such high surface roughness reduces a receding contact angle, preventing dewetting, e.g. beading, after flattening and spreading.

Taking into account the above considerations, a specific embodiment of the embodiment shown in FIG. 1 may include an endless belt 18 having a silicone top layer having an E-modulus of about 0.5 MPa and a surface roughness Ra of about 1 micron. The process liquid 30 may comprise water, glycerol, a resin like Ottopol K65 resin and at least one surfactant like Capstone FS-50 and Surfadone LP100. Such a process liquid 30 does not spread sufficiently on the surface of such an endless belt 18 and is therefore flattened at the spreading treatment station 12. Additional drying or curing may be applied at the spreading treatment station 12 for increasing the viscosity of the process liquid 30 applied on the endless belt 18. For example, dry and/or heated air may be blown over the process liquid film 32 and/or a heater like an infrared heater may be applied to heat the process liquid film 32. It is noted that the drying may be performed either before or after the flattening, depending on requirements and specific properties of the process liquid 30 and the surface of the endless belt 18. In any case, as apparent to those skilled in the art, this specific embodiment of a process liquid and an intermediate endless belt is a merely exemplary embodiment and many other process liquids and intermediates are known. Hence, a person skilled in the art is able to select any suitable combination of process liquid, intermediate and ink in dependence of print requirements.

After passing the spreading treatment station 12, the process liquid 30 is transported on the surface of the endless belt 18 to the second print station 14, where an ink 34 is applied on top of the process liquid film 32. The properties of the ink 34 and the process liquid 30 are such that the ink 34 spreads sufficiently over the process liquid film 32 to form a desired print image 36, which then transferred to the recording medium 40 at the transfer station 40 by application of pressure and/or heat and/or any other suitable method. Moreover, the process liquid 30 is as well transferred to the recording medium 40, leaving a clean intermediate medium after the transfer station 16. The clean surface of the endless belt 18 allows the endless belt to travel further and be re-used at the first print station 10 again for generating a next print image.

In a second embodiment of the inkjet printing assembly 1 according to the present invention, as shown in FIG. 2, the spreading treatment station 12 comprises a first thickening device 12b, a flattening unit 12c and a second thickening device 12d. Further, a cleaning station 38 is provided in a return transport path downstream of the transfer station 16. Except the detailed embodiment of the spreading treatment station 12 and the addition of the cleaning station 38, the embodiment of FIG. 2 corresponds to the embodiment of FIG. 1 and is therefore not further elucidated here.

The spreading treatment station 12 of the embodiment of FIG. 2 comprises the first thickening device 12b for increasing the viscosity of the process liquid 30 present on the surface of the endless belt 18 prior to subjecting the process liquid 30 to flattening. Such thickening may be achieved by drying (i.e. evaporation of a carrier fluid such as water or any other solvent) or curing (i.e. physical process such as cooling or chemical process such as cross-linking of compounds affecting the viscosity and/or resulting in a (partial) phase change of the process liquid 30).

For example, the process liquid may have a gelling composition and be curable by UV radiation. Such a process liquid 30 may be jetted at an elevated temperature to cool down on the endless belt 18 to a gelled state assisted by the first thickening device 12b, e.g. by blowing cool air over the process liquid 30. It is noted that the first thickening device 12b may be arranged below the endless belt 18 such to cool the endless belt 18, for example. The same may apply to any other kind of treatment device, where appropriate and suitable, as apparent to those skilled in the art.

Then, after having thickened, the process liquid 30 is flattened by the flattening device 12c. The flattening device 12c may be a wiper or a roller (shown) or any other element arranged over the surface of the endless belt 18 pressing the beaded droplets of process liquid 30 onto the surface of the belt 18, thereby spreading the process liquid 30 to a process liquid film 32. Due to the previous thickening, the process liquid 30 is prevented to easily bead again. Still, the second thickening device 12d may further increase the viscosity by drying and/or curing to stabilize the process liquid film 32, for example.

The second thickening device 12d may induce a same kind of thickening of the process liquid 30 as the first thickening device 12b or may induce a different process. For example, referring to the example of the gelling process liquid, the process liquid 30 in the gelled state and flattened by the flattening device 12c may be pre-cured by application of a low dose of UV-radiation to control and stabilize the process liquid film 32 but without preventing transfer to and adherence to the recording medium 40 in the transfer station 40.

The process liquid composition mentioned as a specific embodiment of the embodiment of FIG. 1 is neither a gelling composition nor a UV-radiation curable composition. For such process liquid it may suffice to provide a flattening device 12c, optionally further provided with one or two drying devices 12b, 12d upstream and/or downstream, respectively, for evaporating the water from the composition, which will result in the viscosity of the process liquid increasing.

While in the embodiment of FIG. 1 it is presumed that all ink 34 and process liquid 30 is transferred to the recording medium 40 in the transfer station 16, in practice such 100% transfer may not be achieved. Therefore, the cleaning station 38 is provided in the embodiment of FIG. 2. The cleaning station 38 applies any suitable kind of cleaning process to clean the surface of the endless belt 18. For example, a cleaning liquid may be applied, a scraper may be applied, heating may be applied or any other known cleaning process may be selected and applied as apparent to those skilled in the art.

FIG. 3 shows another embodiment of an inkjet printing assembly 1, wherein the transport path along the first print station 10, the spreading treatment station 12, the second print station 14 and the transfer station 16 is provided by an endless belt 18, but, as compared to the embodiments of FIGS. 1 and 2, the endless belt does not function as the intermediate medium. In this embodiment, the endless belt 18 is configured to transport an intermediate sheet 118 along the transport path. Moreover, the endless belt 18 is also configured to transport a sheet of recording medium 40 along the transport path. Thus, the inkjet printing assembly 1 is not only arranged for indirect inkjet printing, but is as well arranged for direct inkjet printing.

Referring to FIG. 3 in more detail, an intermediate sheet input station 120 is provided and configured for holding an amount of intermediate sheets 118. Further, optionally, a recording medium input station 150 is provided and configured for holding an amount of sheets of the recording medium 40. Either input station 120, 150 is configured to provide a sheet to the surface of the endless belt 18. For example and as illustrated, a first intermediate sheet 118a is being supplied from the intermediate sheet input station 120 to the endless belt 18; a second intermediate sheet 118b is at the first print station 10; a first recording medium sheet 40a is at the spreading treatment station 12; a second recording medium sheet 40b is at the second print station 14; a third intermediate sheet 118c is at the transfer station 16; a fourth and a fifth intermediate sheet 118d, 118e are at the cleaning station 38 and a sixth intermediate sheet 118f is being provided to an intermediate sheet receiving station 122. A free space 126 on the endless belt 18 at the cleaning station 38 may have been created due to a sheet of the recording medium 40 having been printed and received in a recording medium output station 130. A third recording medium sheet 40c is provided from another source than the recording medium input station 150 and is not printed on directly by the first and second print stations 10, 14, but receives a print image in the transfer station 16 from the third intermediate sheet 118c.

A intermediate sheet return path 124 is schematically shown to indicate that the cleaned intermediate sheets 118 may be returned to the intermediate sheet input station 120, either automatically by a suitable transport mechanism, which may be designed and provided by those skilled in the art, or the cleaned intermediate sheets 118 may be returned to the intermediate sheet input station 120 manually by an operator. Of course, any other suitable method and/or assembly for returning the cleaned intermediate sheets 118 may be suitably selected and applied as well, as apparent to those skilled in the art.

In operation, the inkjet printing assembly 1 may employ a direct inkjet process by supplying a recording medium 40 from the recording medium input station 150 to the surface of the endless belt 18. The recording medium 40 then passes the first print station 10, where in this embodiment there are two print heads 10a, 10b. Both may be configured to apply a same process liquid in a larger amount, for example. On the other hand, each print head 10a, 10b may be configured to apply a different kind of process liquid 30. For example, if a recording medium 40 is used and passes the first print station 10, a priming liquid or a pinning liquid may be applied on the recording medium 40. Such liquids are well known in the art and further elucidation is therefore omitted here. Such a priming or pinning liquid applied to a recording medium 40 may obviate the need for a treatment at the treatment station 12 or the spreading treatment station 12 may stimulate drying, for example. While in FIG. 3 a single spreading treatment unit 12a is shown, it is noted that the spreading treatment station 12 may be embodied in any suitable way, for example in accordance with the second embodiment of FIG. 2.

After passing the spreading treatment station 12, the recording medium 40 arrives at the second print station 14, where an image is provided on the recording medium 40 by patterned application of droplets of the ink 34.

The recording medium 40 is subsequently transported to the transfer station 16. At the transfer station 16, there is no recording medium sheet 40c as shown in FIG. 3, but the recording medium 40 is transported through the nip formed by the roller 20 and the counter roller 24 into the recording medium output station 130. Thereto, the transfer station 16 may be provided with means for separating the recording medium 40 from the endless belt 18 and guiding the recording medium 40 in the direction of the recording medium output station 130. Such means are well known in the art and are not further elucidated herein. A free space 126 remains then on the endless belt 18, which returns around roller 122 to the input stations 120, 150.

Further, in operation, the inkjet printing assembly 1 may employ an indirect inkjet process by supplying an intermediate sheet 118 from the intermediate medium input station 120 to the surface of the endless belt 18. The intermediate sheet 118 then passes the first print station 10. In this embodiment there with two print heads 10a, 10b, if an intermediate sheet 118 is used and passes the first print station 10, a spreading agent or release agent may be applied as a process liquid 30 on the intermediate sheet 118 in accordance with the first and second embodiments of FIGS. 1 and 2, respectively. Similarly, the spreading treatment station 12 may perform any suitable treatment of the process liquid 30 in accordance with the first and second embodiments of FIGS. 1 and 2, respectively.

After passing the spreading treatment station 12, the intermediate sheet 118 arrives at the second print station 14, where an image is provided on the process liquid 30, which is present on the intermediate sheet 118, by patterned application of droplets of the ink 34.

The intermediate sheet 118 is subsequently transported to the transfer station 16. At the transfer station 16, there is a recording medium sheet 40c as shown in FIG. 3. The intermediate sheet 118 and the recording medium sheet 40c are transported together through the nip formed by the roller 20 and the counter roller 24, due to which the print image 36 is transferred from the intermediate sheet 118 to the recording medium sheet 40c. The recording medium 40 is then transported into the recording medium output station 130. Thereto, the transfer station 16 may be provided with means for guiding the recording medium 40 from said nip in the direction of the recording medium output station 130. Such means are well known in the art and are not further elucidated herein. The intermediate sheet 118 is held on the surface of the endless belt 18 and turns around the roller 20 in the direction of the cleaning station 38. At the optional cleaning station 38, the intermediate sheet 118 may be cleaned to remove any remaining process liquid 30 and/or ink 34. The intermediate sheet 118 may then be returned to the intermediate sheet input station 120 for re-use.

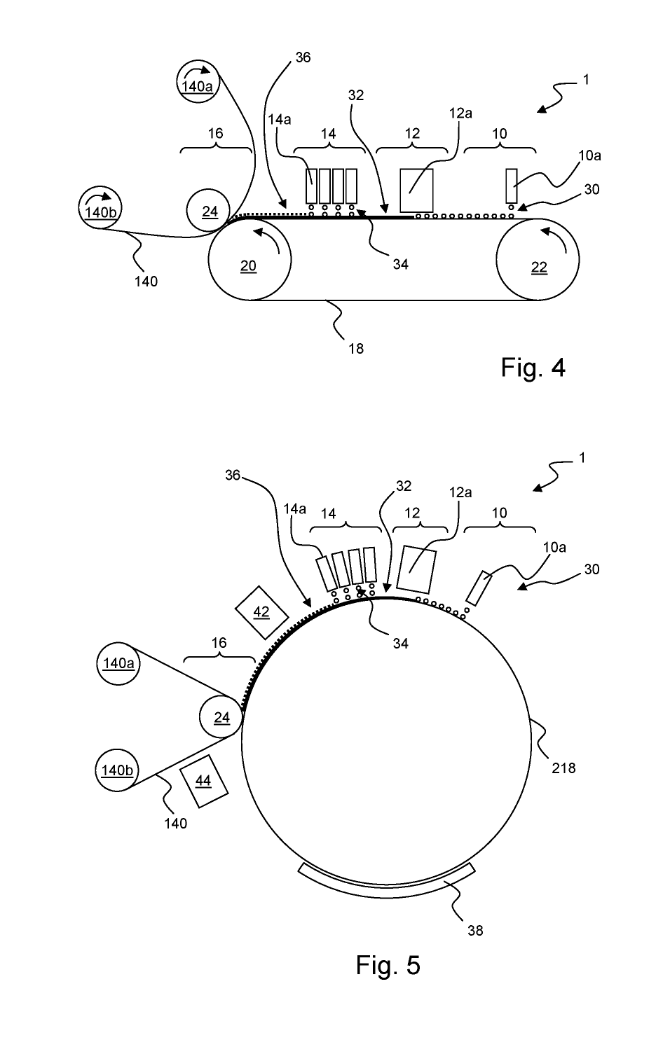

Thus, in the third embodiment of FIG. 3, the inkjet printing assembly 1 may perform a direct print process or an indirect print process, enabling a large range of medium types to be printed on. The media versatility and application versatility are further increased by use of the first print station 10 for applying the process liquid image-wise in combination with the spreading treatment of the process liquid at the spreading treatment station 12. The fourth embodiment shown in FIG. 4 corresponds mostly with the first embodiment of FIG. 1, except that a recording medium 140 is a web, which is supplied from a supply roll 140a and is received at a receiver roll 140b. The recording medium 140 is transported through the nip of the transfer station 16 and receives in said nip the print image 36 from the intermediate endless belt 18.

Of course, the use of a web instead of sheets as a recording medium may be applied in the second and third embodiments of FIGS. 2 and 3 as well. In particular, in the embodiment of FIG. 3, this may provide for an inkjet print assembly 1 that is configured to print both on a web and a sheet. Still, in such embodiment, additional means may be needed to ensure that a recording medium sheet having been printed on is not brought into contact with the web. For example, the counter roller 24 in the embodiment of FIG. 4 may be arranged such that it may be lifted away from the roller 20, allowing the printed recording medium sheet 40 to pass through the open nip and be transported into the recording medium output station 130 (FIG. 3).

In the fifth embodiment as shown in FIG. 5, the endless belt has been replaced by a roller or drum 218, technically providing the same functionality as the endless belt and as such the drum 218 may be applied in any of the preceding embodiments shown in FIGS. 1-4.

In FIG. 5 further treatment units 42, 44 are shown. A first post-print treatment unit 42 is provided over the surface of the drum 218 downstream of the second print station 14 and upstream of the transfer station 16. The first post-print treatment unit 42 allows to treat the ink 34 applied as the print image 36 prior to transfer to the recording medium 140. For example, pre-transfer drying may be performed to prevent a relatively large amount of solvent such as water to penetrate into the recording medium 140, which may for example be a paper or paper-like medium. As a large amount of water absorbed in a fibrous paper-like medium may result in deformations of the recording medium, such as cockling, it may be preferred to reduce the amount of solvent arriving at the transfer station 16.

A second post-print treatment unit 44 is shown to be positioned downstream of the transfer station 16 and upstream of the receiver roll 140b. The second post-print treatment unit 44 may also be a drying unit, but in this case for providing post-transfer drying and thus for removing as much solvent from the printed recording medium 140b before the recording medium 140 is wound around the receiver roll 140b. An insufficiently dried printed recording medium 140 would result in the printed image 36 being transferred to other parts of the web of recording medium and other artifacts. It is noted that the post-print treatment units 42, 44 may be applied as well in combination with an endless belt and/or in combination with sheets of recording medium. Further, the post-print treatment units 42, 44 are not limited to drying units, but may be configured to provide for any kind of post-print treatment, including but not limited to curing, cooling and heating. A person skilled in the art is presumed to be enabled to select and provide for such post-print treatment units in accordance with the requirements imposed by the selected print process and properties of the process liquid, the ink, the recording medium and any other relevant properties.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims is herewith disclosed.

Further, it is contemplated that structural elements may be generated by application of three-dimensional (3D) printing techniques. Therefore, any reference to a structural element is intended to encompass any computer executable instructions that instruct a computer to generate such a structural element by three-dimensional printing techniques or similar computer controlled manufacturing techniques. Furthermore, such a reference to a structural element encompasses a computer readable medium carrying such computer executable instructions.

Further, the terms and phrases used herein are not intended to be limiting; but rather, to provide an understandable description of the invention. The terms “a” or “an”, as used herein, are defined as one or more than one. The term “plurality” or “multiple”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An inkjet printing assembly for providing an imaging liquid on a recording medium, the inkjet printing assembly comprising a transport path for transporting an intermediate medium, the inkjet printing assembly having arranged along said transport path
a first inkjet print station for ejecting a process liquid on an intermediate medium prior to ejecting the imaging liquid on the intermediate medium;
a second inkjet print station for ejecting the imaging liquid on the intermediate medium;
a spreading treatment station arranged between the first print station and the second print station, wherein the spreading treatment station is configured to spread the process liquid on the intermediate medium before receiving the imaging liquid on the intermediate medium; and
a transfer station for transferring at least the imaging liquid from the intermediate medium to the recording medium.

2. The inkjet printing assembly according to claim 1, wherein the intermediate medium is formed by an endless belt being driven along said transport path.

3. The inkjet printing assembly according to claim 1, wherein a transport medium is configured for carrying the intermediate medium along the transport path.

4. The inkjet printing assembly according to claim 3, wherein the transport medium is further configured for carrying the recording medium along the transport path.

5. The inkjet printing assembly according to claim 1, wherein the spreading treatment station comprises a flattening device for flattening droplets of process liquid arranged on the intermediate medium.

6. The inkjet printing assembly according to claim 5, wherein the flattening device is selected from a group of flattening devices comprising a roller and a wiper.

7. The inkjet printing assembly according to claim 1, wherein the spreading treatment station comprises a thickening device for increasing a viscosity of the process liquid arranged on the intermediate medium.

8. The inkjet printing assembly according to claim 7, the spreading treatment station further comprising a flattening device for flattening droplets of process liquid arranged on the intermediate medium and wherein the thickening device is arranged upstream of the flattening device.

9. The inkjet printing assembly according to claim 7, the spreading treatment station further comprising a flattening device for flattening droplets of process liquid arranged on the intermediate medium and wherein the flattening device and the thickening device are embodied in a single element.

10. The inkjet printing assembly according to claim 9, wherein the single element is a heated roller arranged over the transport path, the process liquid being flattened by pressure exerted by the roller and the process liquid being thickened by being at least partly dried by the heat applied by surface contact between the roller and the process liquid.

11. The inkjet printing assembly according to claim 1, wherein the inkjet printing assembly further comprises a cleaning station arranged downstream of the transfer station for cleaning the intermediate medium and wherein a return transport path is provided for returning the intermediate medium to the first printing station.

12. An inkjet printing method for providing an imaging liquid on a recording medium, the inkjet printing method comprising transporting an intermediate medium along a transport path, wherein the method further comprises:
ejecting a process liquid on the intermediate medium prior to ejecting the imaging liquid on the intermediate medium at a first inkjet print station;
ejecting the imaging liquid on the intermediate medium at a second inkjet print station;
spreading the process liquid on the intermediate medium before receiving the imaging liquid on the intermediate medium at a spreading treatment station arranged between the first print station and the second print station; and
transferring at least the imaging liquid from the intermediate medium to the recording medium at a transfer station.

13. The inkjet printing method according to claim 12, wherein the process liquid is applied on the intermediate medium only at a position where the imaging liquid is to be applied.

14. The inkjet printing method according to claim 12, wherein the process liquid has a non-wetting property on the intermediate medium such that the process liquid may form beads on the intermediate medium and wherein in the step of spreading the process liquid on the intermediate medium comprises flattening beads of process liquid.

15. The inkjet printing method according to claim 12, wherein the step of spreading the process liquid at the spreading treatment station further comprises increasing a viscosity of the process liquid.
